(19) United States
(12) Patent Application Publication
(10) Pub. No.: US 2026/0353409 A1
(43) Pub. Date: Nov. 5, 2026

(54) Terminal, System, and Method for Selecting Channel Resources in Sidelink Transmissions

(71) Applicant: Apple Inc., Cupertino, CA (US)

(72) Inventors: Chunxuan Ye, San Diego, CA (US); Haitong Sun, Saratoga, CA (US); Sigen Ye, San Diego, CA (US); Ankit Bhamri, Haar (IN); Chunhai Yao, Beijing (CN); Hong He, San Jose, CA (US); Dawei Zhang, Saratoga, CA (US); Huaning Niu, San Jose, CA (US); Weidong Yang, San Diego, CA (US); Wei Zeng, Saratoga, CA (US)

(21) Appl. No.: 19/102,837

(22) PCT Filed: Aug. 12, 2022
(86) PCT No.: PCT/CN2022/112161

§ 371 Date: Feb. 10, 2025

(51) Int. Cl. H04W 72/25; H04L 5/00; H04W 56/00; H04W 72/02

(52) U.S. Cl. CPC H04W 72/25; H04L 5/0094; H04W 56/001; H04W 72/02

(57) ABSTRACT

A terminal may include a receiver configured to receive configuration parameters for a sidelink (SL) transmission that includes resources selected from a portion of an unlicensed spectrum. The configuration parameters may indicate definitions for a Sidelink synchronization signal block (“S-SSB”) transmission timing or an S-SSB frequency structure of the SL transmission. The terminal may include a processor configured to perform a resource selection procedure that include resources selected for the SL transmission in accordance with the S-SSB transmission timing or the S-SSB frequency structure. The terminal may include a transmitter configured to transmit, to the other terminal, the SL transmission.

### FIELD

The present application relates to wireless devices and wireless networks, including devices, circuits, and methods for performing Sidelink communication procedures.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

In one or more embodiments, a terminal includes a receiver configured to receive configuration parameters for a sidelink (SL) transmission that includes resources selected from a portion of an unlicensed spectrum. The configuration parameters indicate definitions for an a Sidelink synchronization signal block (“S-SSB”) transmission timing or an S-SSB frequency structure of the SL transmission. The terminal includes a processor configured to perform a resource selection procedure that includes resources selected for the SL transmission in accordance with the S-SSB transmission timing or the S-SSB frequency structure. The terminal includes a transmitter configured to transmit, to the other terminal, the SL transmission.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a BS, according to some aspects.

FIG. 4 illustrates an example block diagram of wireless communication circuitry, according to some aspects.

FIGS. 5A-5C are diagrams illustrating examples of Sidelink Synchronization Signal Block (“S-SSB”) configuration structures, according to some aspects.

FIGS. 6A-6C are diagrams illustrating examples of S-SSB configuration structures, according to some aspects.

FIG. 7 is a flowchart detailing a method of selecting resources in S-SSB structures, according to some aspects.

FIG. 8 is a diagram illustrating an example of an SL transmission configuration, according to some aspects.

FIG. 9 is a diagram illustrating an example of an SL transmission configuration, according to some aspects.

FIG. 10 is a diagram illustrating an example of an SL transmission configuration, according to some aspects.

FIGS. 11A and 11B are diagrams illustrating examples of cyclic shift pairs configurations, according to some aspects.

FIG. 12 is a flowchart detailing a method of selecting resources in an SL transmission, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study and evaluate enabling Sidelink (SL) communication procedures, signaling, and resource selection on portions of an unlicensed spectrum in 5G/New Radio (NR) environments. Thus, disclosed herein are various solutions for performing and improving SL transmissions on portions of the unlicensed spectrum, including: 1) resource selections in S-SSB structures; 2) resource selections for configuring S-SSB occasions; and 3) resource selections for PSFCH retransmissions.

In accordance with one or more embodiments, a user equipment (UE) device or terminal communicating with other terminals (other wireless communication devices, network devices, UE devices, and/or Base Station (BS) devices) may perform radio transmissions including SL communication procedures on portions of the unlicensed spectrum. The SL communication procedures may be configured to include one or more resource allocation procedures supported by radio interface operations between UE and BS (Uu). The Uu interface or link refers to the air interface between the UE and the Radio Access Network (RAN), while the sidelink interface refers to the interface between UEs. SL communications may include unicast communication from a UE device to a BS device or another UE device, as well as unicast or multicast communication from the BS device or the other UE device to the UE device. The first communication mode may include receiving a resource allocation configuration indicating a resource allocation pattern from a core network over the Uu link. The second communication mode may include receiving the resource allocation configuration from the other UE device in one or more resource pools. The first communication mode and the second communication mode may be further defined in the same manner as resource allocation mode 1 and resource allocation mode 2 are respectively described in TS 38.300 of the 3GPP standard.

In some embodiments, the unlicensed spectrum are individual unlicensed bands in a bandwidth with a range between 4.1 gigahertz (GHz) and 7.125 GHz. For example, the unlicensed bands may be in the ranges between 5.150 GHz and 5.925 GHz and between 5.925 GHz and 7.125 GHz, which respectively correspond to NR bands n46 and n96/n102 of the Frequency Range (FR1) defined in TS 38.101 of the 3GPP standard.

In one or more embodiments, individual bandwidth parts (BWPs) may be configured to perform the SL transmissions. In some embodiments, an SL BWP is a contiguous set of physical resource blocks (PRBs) in an SL transmission, selected from a contiguous subset of common resource blocks (RBs) for a given numerology (u) on a given carrier configured for an SL communication procedure. Each SL BWP may be defined for the given numerology (u) in relation to a subcarrier spacing, a symbol duration, and/or a cyclic prefix (CP) length. A UE device may be configured with four SL BWP for downlink and uplink. One of the SL BWPs may be active for downlink or uplink at any point in time. The SL BWP may be preconfigured (e.g., configured from factory settings) or dynamically configured (e.g., configured from the core network via a BS device or a UE device) to include multiple SL resource pools. At least one SL resource pool May be (pre-)configured in accordance with an integer number of RB sets. The SL resource pool may be a predefined resource pool configured to include a sub-set of PRBs of one RB set. Further, the SL resource pool may be configured in relation to a sub-channel size and a number of sub-channels in the SL resource pool if the SL resource pool includes at least two adjacent RB sets.

In one or more embodiments, the SL communication procedure includes selecting resources for SL transmissions in SL physical channels. Some SL physical channels include Physical Sidelink Broadcast Channel (“PSBCH”), Physical Sidelink Control Channel (“PSCCH”), Physical Sidelink Shared Channel (“PSSCH”), and Physical Sidelink Feedback Channel (“PSFCH”). The PSCCH and PSFCH are standalone channels. The PSCCH includes a part of the Sidelink Channel Information (“SCI”), while the PSSCH may include the rest. The PSFCH may include Sidelink Feedback Control Information (“SFCI”) and HARQ feedback for PSSCH reception. These physical channels may include SL-specific physical signals such as DM-RS, CSI-RS, PT-RS, Sidelink Primary Synchronization Signal (“S-PSS”), and Sidelink Secondary Synchronization Signal (“S-SSS”). The PSCCH may be associated with the DM-RS. Further, the PSSCH may be associated with the DM-RS and the PT-RS. The SL communication procedure may include selecting SL physical channel resources in accordance with one or more Sidelink Synchronization Signal Block (“S-SSB”) structures.

In one or more embodiments, a terminal is configured receive configuration parameters for an SL transmission that includes resources selected from a portion of an unlicensed spectrum. The configuration parameters may indicate definitions for an S-SSB transmission timing or an S-SSB frequency structure of the SL transmission. The terminal may perform a resource selection procedure that includes resources selected for the SL transmission in accordance with the S-SSB transmission timing or the S-SSB frequency structure.

In some embodiments, the S-SSB frequency structure may include a numerology and a resource selection information. The numerology may indicate that a subcarrier spacing is equal to a first value or a second value. The first value may be larger than the second value. The resource selection information may indicate selection of a first number of resources to a first portion of a Physical Sidelink Broadcasting Channel (“PSBCH”) and a second number of resources to a second portion of the PBSCH. In some embodiments, when the subcarrier spacing is equal to the first value, the resource selection information selects a first set of resources to the first portion of the PSBCH. In other embodiments, when the subcarrier spacing is equal to the second value, the resource selection information selects a second set of resources to the first portion of the PSBCH. The second set of resources may be equal to or greater than the first set of resources. In some embodiments, the resources selected for different portions of the PSBCH may be equal or different from one portion to one another.

Further, the resource selection information selects resources for an automatic gain control (“AGC”) symbol. The AGC symbol may be a copy of a first SL Primary Synchronization Signal (“S-PSS”) symbol or a last SL Secondary Synchronization Signal (“S-SSS”) symbol in the S-SSB frequency structure. The resource selection may indicate an interlace structure for the second set of resources. The interlace structure may indicate whether the second set of resources is equal to or greater than the first set of resources. The resource selection may indicate an interlace structure for the second set of resources. The interlace structure may indicate whether the second set of resources is equal to or larger than the first set of resources.

In one or more embodiments, the S-SSB transmission timing indicates an S-SSB timing structure for the SL transmission. The S-SSB timing structure may include a resource selection information defining at least one S-SSB occasion in a slot. A number of S-SSB occasions in the slot may be configured, preconfigured, or predefined. The resource selection information may indicate locations in the slot for a symbol offset, a first S-SSB occasion, a symbol gap, and a second S-SSB occasion. The symbol offset may be at a beginning of the slot and before the first S-SSB occasion. The symbol gap may be between the first S-SSB occasion and the second S-SSB occasion. The S-SSB occasion may include a duration of four symbols and one automatic gain control (“AGC”) symbol in the slot. The resource selection information may indicate locations in the slot a first AGC symbol, a second AGC symbol, a third AGC symbol, a first S-SSB occasion, a second S-SSB occasion, a third S-SSB occasion, and a symbol gap.

In some embodiments, the S-SSB timing structure includes a resource selection information defining multiple S-SSB slot occasions in multiple S-SSB bunches, a number of S-SSB slot occasions in the S-SSB bunches, and a number of the S-SSB bunches. The multiple numbers may be configured, (pre-)configured, or predefined via dynamic configuration. In other embodiments, the resource selection information indicates locations in the S-SSB bunches for the multiple S-SSB slot occasions, multiple intra-bunch gaps, and at least one inter-bunch gap.

In some embodiments, the terminal may receive configuration parameters for an SL transmission that includes resources selected from a portion of an unlicensed spectrum. The configuration parameters may indicate a resource selection pattern for an SL sub-channel in the SL transmission. The terminal may perform a resource selection procedure that includes resources selected for the SL transmission in accordance with the resource selection pattern; and a transmitter configured to transmit the SL transmission.

In one or more embodiments, the SL transmission includes a Physical Sidelink Feedback Channel (“PSFCH”) transmission that meets an Occupied Channel Bandwidth (“OCB”)/Power Spectral Density (“PSD”) requirement. The PSFCH transmission may use a same interlace as a corresponding Physical Sideling Control Channel (“PSCCH”)/Physical Sidelink Shared Channel (“PSSCH”) transmission

The UE device may be configured to perform one or more SL transmissions as part of the SL communication procedure. The one or more SL transmissions may be transmissions (or reception of transmissions) following protocols in which the UE device selects resources in accordance with the indexed frequency resources.

The UE device may implement the SL communication procedure upon receiving instructions from one of its neighboring terminals or upon receiving approval from one of its neighboring terminals after requesting an initialization of the SL communication procedure. The UE device may coordinate the SL transmissions with terminals connected through multiple radio access technologies (RATs) (i.e., LTE-A, 5G NR, and the upcoming 6G).

In some embodiments, the UE device is configured to perform the SL transmissions without negatively impacting a user's experience. To achieve this, the UE device selects resources in the unlicensed spectrum without taking data integrity away from communication resources selected in the licensed spectrum of a same SL transmission. Successful selection of frequency resources in the unlicensed spectrum and the licensed spectrum in the same SL transmission may prevent data rate reductions, delay increases, or jitter. In this regard, the UE device obtains communication parameters that define reference information indicating resource selections for the SL communication procedure. The UE device may use the communication parameters to determine a resource selection pattern to be used in the SL transmission procedure.

The resource selection pattern may be determined based on parameters obtained for the SL transmission procedure. In one or more embodiments, the UE device identifies an SL resources pool including a set of SL resources for communicating directly with one or more additional terminals in the SL transmission procedure. The resource selection pattern may be determined based on the SL resources pool identified and/or may include resources selected from at least a portion of the set of SL resources in the SL resources pool. The SL resources pool may be an existing SL resources pool previously configured for the SL communication procedure and/or may be an independent SL resources pool selected specifically for the SL communication procedure.

The UE device may initiate the SL communication procedure by transmitting, to the neighboring terminal, a broadcasting signal, which may include terminal capability and at least one communication request. The terminal capability may be communication information regarding one or more transmission and reception capabilities of the UE device, while the communication request may include a request for a start of the communication procedure to the neighboring terminal.

As described above, the parameters may be received by the UE device from the neighboring terminal via an SL communication link. If the neighboring terminal is another UE device, the parameters may be obtained from the other UE device via additional communication links established with a core network. If the neighboring terminal is a base station, the parameters may be obtained from the base station via higher layer signaling (e.g., signaling received from upper layers using Radio Resource Control (RRC) messaging or medium Access Control (MAC) messaging in devices connected to the core network).

The following is a glossary of terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

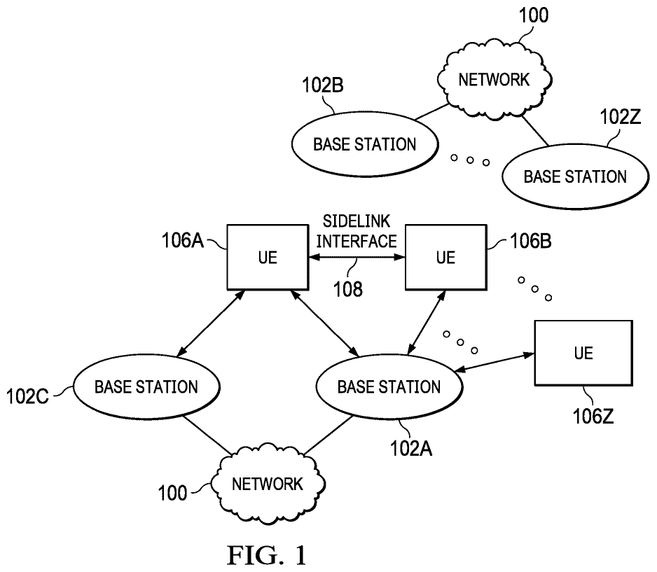

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherpr23 enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Description of Sidelink (SL) Communication Links

In one or more embodiments, SL communication links are communication links established between terminals acting as UE devices. In SL communication links, each aforementioned physical channels corresponds to a set of resource elements carrying information originating from higher layers. These physical signals may include reference information signaling and synchronization information signaling. The reference information signaling may include reference information identifying at least one terminal a positioning reference using a reference signal (e.g., a demodulation reference signal). The positioning reference may be a terminal that is configured to obtain its absolute location on Earth or location within a specific area. The synchronization information signaling may include synchronization information relating to allocation of resources for at least one synchronization signal.

In one or more embodiments, two UE devices communicating with one another may exchange SL transmissions using the SL communication link. The SL communication link may be defined for 5G NR in TS 38.331 of the 3GPP standard.

The reference signal is used to provide multiple terminals with a baseline transmission information that these terminals may identifying on SL transmissions exchanged with one other. As described above, reference signals are predefined signals occupying specific resource elements within a communication time-frequency grid. In the NR specification, multiple types of reference signals may be transmitted in different ways and intended to be used for different purposes by a receiving device. In this disclosure, the reference signals are modified for implementation in SL transmissions.

Examples of synchronization information may include communication information relating to selection of resources for at least one synchronization signal. A first option for the synchronization signal may be a Demodulation Reference Signal (DMRS) used for the PSCCH. In an Orthogonal Frequency Division Multiplexing (OFDM) symbol for the PSSCH, the synchronization signal may be the associated DMRS. A second option for the synchronization signal may be a DMRS for Demodulation Reference Signal (DMRS) used for the PSSCH. A third option for the synchronization signal may be a Phase Tracking Reference Signal (PTRS) configured to track phase changes and compensate phase noise during SL transmissions, which may be used for higher carrier frequencies. A time density and a frequency of the PTRS may be configured by the upper layers and may be configured per resource pool. A fourth option for the synchronization signal may be a Channel-State Information Reference Signal (CSI-RS). The CSI-RS may be used for channel sounding. The receiving device may measure the received CSI-RS, then may report back the CSI to the transmitter via the PSSCH. The CSI-RS may be configurable in both the time domain and frequency domain. The CSI-RS may be used to provide fine channel state information. A fifth option for the synchronization signal may be a Synchronization Signal (SS)/PSBCH Block. A slot that transmits the SS/PSBCH block may be referred to as a Sidelink Synchronization Signal Block (S-SSB). The SS/PSBCH block may include PSBCH, Sidelink Primary Synchronization Signal (SPSS) and Sidelink Secondary Synchronization Signal (SSSS) symbols. The period of the S-SSB transmission may be 16 frames, and within each period, the number of S-SSB blocks N in the S-SSB period is configured at the RRC. The range of choices for N may vary based on the numerology and the frequency range.

In one or more embodiments, the UE devices are configured to handle simultaneous sidelink and uplink/downlink transmissions. If any of the UE devices include limited reception capabilities in comparison to the rest of the UE devices, this UE device may prioritize sidelink communication reception, sidelink discovery reception on carriers configured by the eNodeB, and last sidelink discovery reception on carriers not configured by the gNB.

Sidelink transmissions may be organized into radio frames with a duration of T_{f}, each consisting of 20 slots of duration Tₛₗₒₜ. A sidelink subframe consists of two consecutive slots, starting with an even-numbered slot. A transmitted physical channel or signaling in a slot may be described by a resource grid corresponding to a first number of subcarriers and a second number of Single-Carrier (SC)-Frequency Division Multiple Access (FDMA) symbols.

In some embodiments, SL transmissions may be configured in accordance with a resource allocation pattern provided by the gNB. The resource allocation pattern may provide dynamic grants of sidelink resources, as well as grants of periodic sidelink resources configured semi-statically by sidelink configured grants. To improve a reliability of the SL transmissions, a dynamic sidelink grant DCI may provide resources for one or multiple transmissions of a transport block. The sidelink configured grants may be SL transmissions configured to be used by the UE device immediately, until these grants are released by RRC signaling. The UE device may be allowed to continue using this type of sidelink configured grants when beam failure or physical layer problems occur in NR access links (Uu) until a Radio Link Failure (RLF) detection timer expires, before falling back to an exception resource pool. Another type of sidelink configured grant may be a grant that is configured once and may not be used until the gNB sends the UE device a DCI indicating that the grant is now active, and until another DCI indicates deactivation.

In the sidelink configured grants, the resources are a set of sidelink resources recurring with a periodicity which the gNB matches resourced to those characterize for V2X traffic. Multiple configured grants can be configured, to allow provision for different services, traffic types, and the like. Modulation and Coding Scheme (MCS) information for dynamic and configured grants may be optionally provided or constrained by the RRC signaling instead of the DCI. The RRC may configure exact MCS the uses, or a range of MCSs. The MCS may also be left unconfigured. For the cases where the RRC does not provide the exact MCS, the UE device may be left to select an appropriate MCS itself based on any knowledge it may have of the transport block to be transmitted and sidelink radio conditions. The gNB scheduling activity may be driven by reporting in which the UE device shares its sidelink traffic characteristics to the gNB, or by performing a sidelink Buffer Status Report (BSR) procedure similar to that of the Uu to request the sidelink resource allocation from the gNB.

In some embodiments, the SL transmissions for the UE device may be configured in accordance with a self-selected resource allocation pattern (i.e., hereinafter referred to as resource selection pattern). The SL transmissions may be transmitted by the UE device a certain number of times after a resource selection pattern is selected, or until a cause of resource reselection is triggered. The SL transmissions may be performed to support unicast and groupcast communications in the physical layer. The SL transmissions may be configured to reserve resources to be used for a number of blind transmissions or HARQ-feedback-based transmissions of the transport block. The SL transmissions may be performed to select resources to be used for the initial transmission of a later transport block.

In one or more embodiments, the resource allocation patterns selected for the SL transmissions may be implemented in SL Bandwidth Parts (BWP). SL BWP may be sets of contiguous resource blocks configured for the SL transmissions inside a predetermined channel bandwidth. The configuration of the SL BWP and SL resource pools is established by the RRC layer and provided to lower layers when activated. There may be at least one active SL BWP for the UE device at a time in a given frequency band. The SL BWP may be defined by its frequency, bandwidth, Subcarrier Spacing (SCS), and Cyclic Prefix (CP). The SL BWP may define parameters common to all the SL resource pools that are contained within it, namely a number of symbols and starting symbol used for SL in all slots (except those with Synchronization Signal Block (SSB)), power control for PSBCH, and a location of a Direct Current (DC) subcarrier.

The SL BWP may have different lists of SL resource pools for transmissions and receptions, to allow for the UE device to transmit in a pool and receive in another one. For transmissions, there may be one pool for a selected mode, one for a scheduled mode (e.g., when the gNodeB helps with resource selection), and one for exceptional situations. These SL resource pools may be expected to be used for only transmission or reception, except when SL feedback mechanisms are activated, in which case the UE device may transmit Acknowledgement (ACK) messages in a reception pool and receive ACK messages in a transmission pool.

In 5G NR technologies, the SL resource pool may be located inside an SL BWP is defined by a set of contiguous Resource Blocks (RBs) defined by the information element labeled sl-Rb-Number in the frequency domain starting at an RB defined by the information element labeled sl-StartRBsubchannel. Further, the SL resource pool may be divided into sub-channels of a size defined by the information element labeled sl-SubchannelSize, which can take one of multiple values (i.e., 10, 12, 15, 20, 25, 50, 75, and 100). Depending on the value of sl-RB-Number and sl-SubchannelSize, some RBs inside the SL resource pool may not be used by the UEs.

In the time domain, an SL resource pool has some available slots configured by various parameters. To determine which slots belong to the pool, a series of criteria may be applied. The slots where SSB is transmitted may not be used. The number and locations of those slots may be based on a predefined configuration. Slots that are not selected for UL (e.g., in the case of Time Division Multiplexing (TDD)) or do not have all the symbols available (as per SL BWP configuration) may also be excluded from the SL resource pool. Some slots may be reserved such that a number of remaining slots is a multiple of a bitmap length defined by the labels sl-TimeResource-r16 or Lbitmap, that can range from 10 bits to 160 bits. The reserved slots may be spread throughout a variable number of slots. The bitmap sl-TimeResource-r16 may be applied to the remaining slots to compute a final set of identified/labeled slots that belong to the pool.

In some embodiments, the duration of each SL frame and SL subframe is 10 milliseconds (ms) and 1 ms, respectively. The SL frames and SL subframes may include a numerology μ which may define the SCS, a number of slots in a subframe, and cyclic prefix options. In NR SL, the value of μ ranges from 0 to 3. In addition, the supported μ values vary at different frequency bands. In the frequency domain, the SCS may be defined by the numerology. In this regard, the SCS may be directly proportional to the numerology. Within the SL subframe, slots may be numbered from 0 to N subframe. In NR, given that different UE devices may operate in a different BWP and using a different numerology, a common resource block may be used for a device to locate frequency resources within the carrier bandwidth.

In some embodiments, the UE device may allocate channel resources in SL transmissions with one or more BS devices and/or other UE devices. In one example, the UE device may receive configuration parameters for an SL transmission that includes resourced selected from a portion of an unlicensed spectrum. The configuration parameters may indicate definitions for an S-SSB transmission timing or an S-SSB frequency structure of the SL transmission. The UE device may perform a resource selection procedure that includes resources selected for the SL transmission in accordance with the S-SSB transmission timing or the S-SSB frequency structure.

### Example Communication Device

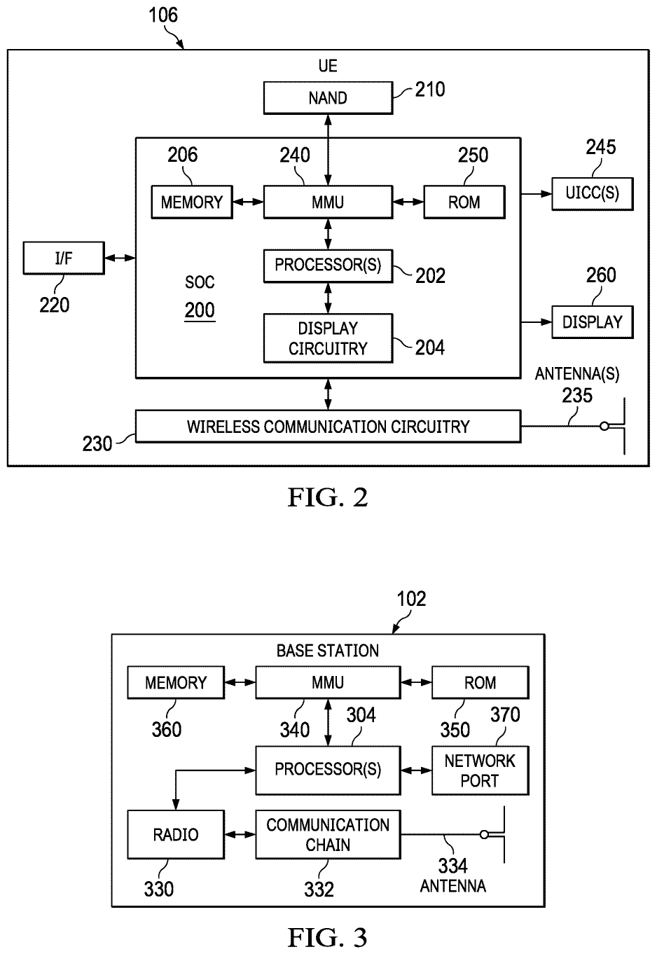

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mm Wave frequency range are heavily attenuated by environmental factors. To help address this attenuating, mm Wave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

FIG. 3 illustrates an example block diagram of a base station 102, according to some aspects. It is noted that the base station of FIG. 3 is a non-limiting example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 304 of the base station 102 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 102, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

### Example Cellular Communication Circuitry

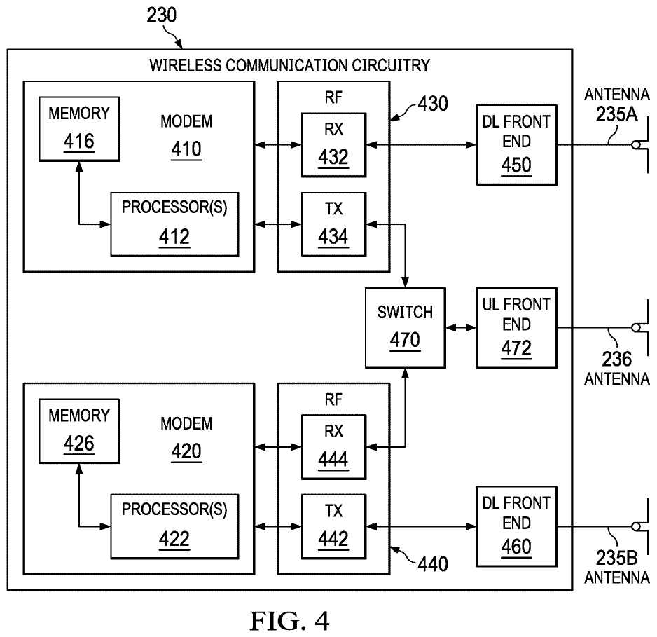

FIG. 4 illustrates an example simplified block diagram of cellular communication circuitry, according to some aspects. It is noted that the block diagram of the cellular communication circuitry of FIG. 4 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 230 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 230 may couple (e.g., communicatively; directly or indirectly) to one or more antennas, such as antennas 235a, 235b, and 236 as shown. In some aspects, cellular communication circuitry 230 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 4, cellular communication circuitry 230 may include a first modem 410 and a second modem 420. The first modem 410 may be configured for communications according to a first RAT, e.g., such as LTE or LTE-A, and the second modem 420 may be configured for communications according to a second RAT, e.g., such as 5G NR.

As shown, the first modem 410 may include one or more processors 412 and a memory 416 in communication with processors 412. Modem 410 may be in communication with a radio frequency (RF) front end 430. RF front end 430 may include circuitry for transmitting and receiving radio signals. For example, RF front end 430 may include receive circuitry (RX) 432 and transmit circuitry (TX) 434. In some aspects, receive circuitry 432 may be in communication with downlink (DL) front end 450, which may include circuitry for receiving radio signals via antenna 235a.

Similarly, the second modem 420 may include one or more processors 422 and a memory 426 in communication with processors 422. Modem 420 may be in communication with an RF front end 440. RF front end 440 may include circuitry for transmitting and receiving radio signals. For example, RF front end 440 may include receive circuitry 442 and transmit circuitry 444. In some aspects, receive circuitry 442 may be in communication with DL front end 460, which may include circuitry for receiving radio signals via antenna 235b.

In some aspects, a switch 470 may couple transmit circuitry 434 to uplink (UL) front end 472. In addition, switch 470 may couple transmit circuitry 444 to UL front end 472. UL front end 472 may include circuitry for transmitting radio signals via antenna 236. Thus, when cellular communication circuitry 230 receives instructions to transmit according to the first RAT (e.g., as supported via the first modem 410), switch 470 may be switched to a first state that allows the first modem 410 to transmit signals according to the first RAT (e.g., via a transmit chain that includes transmit circuitry 434 and UL front end 472). Similarly, when cellular communication circuitry 230 receives instructions to transmit according to the second RAT (e.g., as supported via the second modem 420), switch 470 may be switched to a second state that allows the second modem 420 to transmit signals according to the second RAT (e.g., via a transmit chain that includes transmit circuitry 444 and UL front end 472).

As described herein, the first modem 410 and/or the second modem 420 may include hardware and software components for implementing any of the various features and techniques described herein. The processors 412, 422 may be configured to implement part or all of the features described herein, e.g., by executing program instructions stored on a memory medium (e.g., a non-transitory computer-readable memory medium). Alternatively (or in addition), processors 412, 422 may be configured as a programmable hardware element, such as an FPGA (Field Programmable Gate Array), or as an ASIC (Application Specific Integrated Circuit). Alternatively (or in addition) the processors 412, 422, in conjunction with one or more of the other components 430, 432, 434, 440, 442, 444, 450, 470, 472, 235 and 236 may be configured to implement part or all of the features described herein.

In addition, as described herein, processors 412, 422 may include one or more processing elements. Thus, processors 412, 422 may include one or more integrated circuits (ICs) that are configured to perform the functions of processors 412, 422. In addition, each integrated circuit may include circuitry (e.g., first circuitry, second circuitry, and the like) configured to perform the functions of processors 412, 422.

In some aspects, the cellular communication circuitry 230 may include only one transmit/receive chain. For example, the cellular communication circuitry 230 may not include the modem 420, the RF front end 440, the DL front end 460, and/or the antenna 235b. As another example, the cellular communication circuitry 230 may not include the modem 410, the RF front end 430, the DL front end 450, and/or the antenna 235a. In some aspects, the cellular communication circuitry 230 may also not include the switch 470, and the RF front end 430 or the RF front end 440 may be in communication, e.g., directly, with the UL front end 472.

### Example SL Communication Link Management

SL communication links may be used to help reduce interference and to help support a large number of wireless devices that are neighboring one another. The SL communication links effectively allows transmission and reception of SL transmissions. In some embodiments, the beams are representations of communication being shared between two wireless devices. These SL transmissions may be directed by each wireless device. In some embodiments, the SL transmissions with a predetermined direction may be referred to as beams. As the beams are directed toward a relatively small area as compared to a cell wide signal, a wireless node needs to know where a wireless device is located relative to the wireless node to allow the wireless node to direct beams toward the wireless device.

### Example of a Slot Structure

A slot structure of a radio frame in an SL transmission may include multiple different types of resources. In some embodiments, the resources are selected in a predetermined pattern including 10 PRBs/sub-channels. This predetermined pattern may be a configuration for implementing SL transmissions in 5G NR. The predetermined pattern may include resources selected for a PSCCH, a PSSCH, an automatic gain control (AGC) symbol, a GAP symbol, and a PSFCH symbol including AGC training. In the slot, the AGC symbol may be a copy of a next symbol. The AGC symbol may be used in the slot to automatically control an increase in an amplitude of the radio frame.

In the slot, the AGC symbol may be a first symbol in a slot for AGC training and a first sidelink symbol may be a copy of a second sidelink symbol. The PSCCH may be a channel configured for sidelink control information. The PSCCH may include SL control information (SCI) stage 1 with information related to resource allocation in a first stage SCI A type as defined in TS 38.214 of the 3GPP standard. The PSCCH may start from the second symbol in the slot and may last 2 or 3 symbols in the time domain. The PSCCH may be pre-configured or dynamically assigned. The PSCCH may occupy several contiguous PRBs in the frequency domain. The PSCCH may be configured with candidate numbers including 10, 12, 15, 20, or 25 PRBs. The lowest PRB of the PSCCH is the same as the lowest PRB of the corresponding PSSCH. The PSSCH may be configured for sidelink data. The PSSCH may be configured to include a second stage SCI information about data transmission and feedback in SCI 2-A (e.g., unicast, groupcast, broadcast) and SCI 2-B (e.g., Groupcast) as defined in TS 38.214 of the 3GPP standard. The GAP symbol may be a symbol used for GAP (i.e., Tx/Rx switch) right after a PSSCH transmission. The PSFCH symbol may be configured for sidelink HARQ feedback. The slot may include a PSBCH that may be configured for sidelink broadcast information and an S-SSB for synchronization.

In some embodiments, the slot is included in an SL BWP. The slot may be part of an SL resource pool including a set of time-frequency resources for SL transmission and/or reception. The slot may be used in SL transmissions involving unicast, groupcast, and broadcast for a given UE device.

In 5G NR, the PSCCH and the PSBCH may include a DMRS reused for resource mapping and sequencing. Sidelink CSI-RS may be refined in the PSSCH. The sidelink CSI-RS configuration may be given by a PC5 interface, from the UE device transmitting the sidelink CSI-RS. Sidelink PTRS may be refined in the PSSCH. Further, in 5G NR, a UE device may be configured with one or more reference signal information elements, such as those described in TS 38.211, TS 38.214, and TS 38.331 of the 3GPP standard.

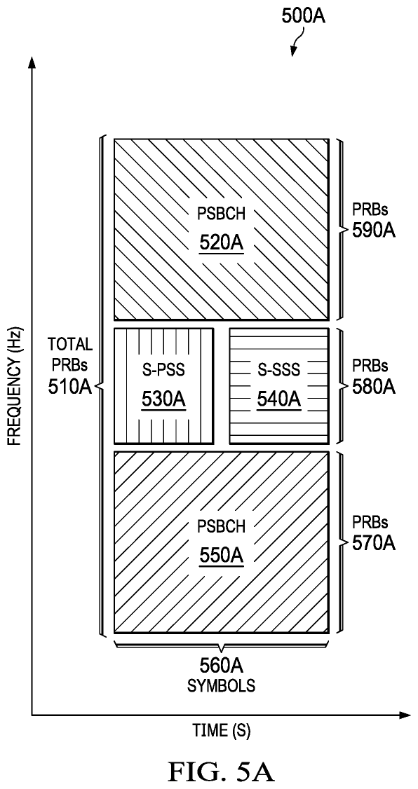

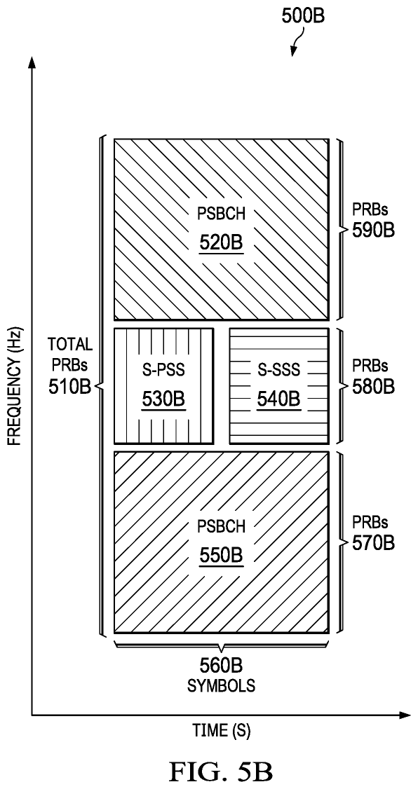

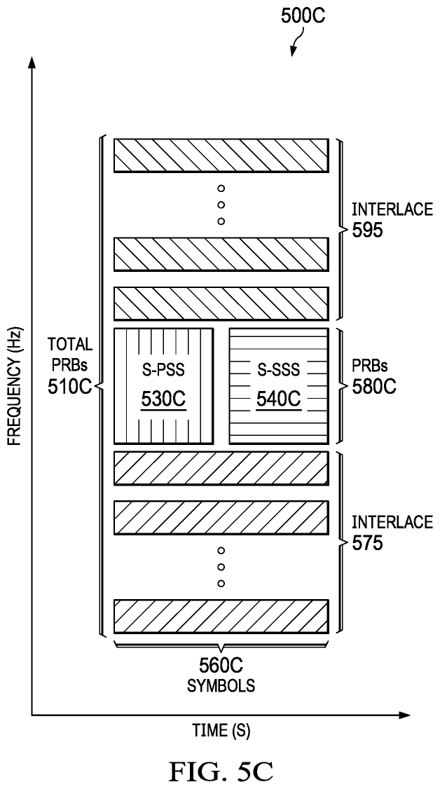

In one or more embodiments, a terminal may receive configuration parameters from a core network (e.g., a gNB) or may receive (pre-)configured parameters. The parameters may be definitions for one or more communication procedures. The parameters may include configuration information to implement an SL communication procedure that includes resources selected from a portion of an unlicensed spectrum. The terminal may be configured to determine, based on the parameters, a resource selection pattern for the SL communication procedure. The terminal may identify an SL resource pool in the parameters. The parameters may be information for selecting resources to one or more PRBs or information for indexing resources to one or more PRBs for a predetermined channel/sub-channel. The parameters may be information for selecting time resources for multiple SL transmissions in a SL communication procedure. The SL transmissions may be one of those described in detail in reference to FIGS. 5A-10.

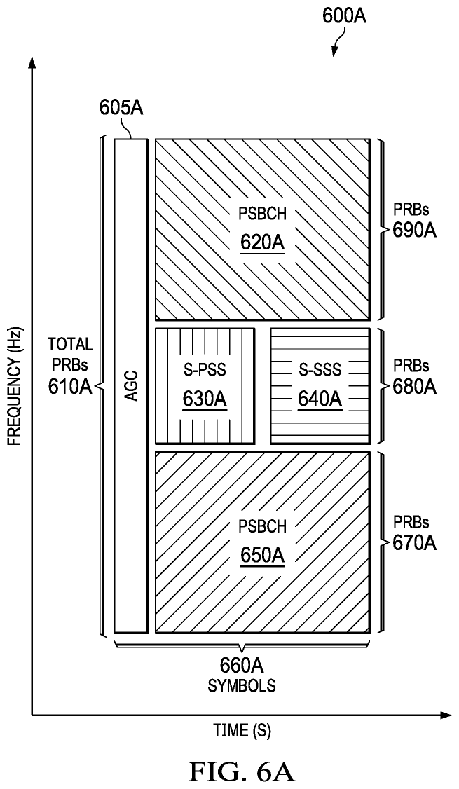

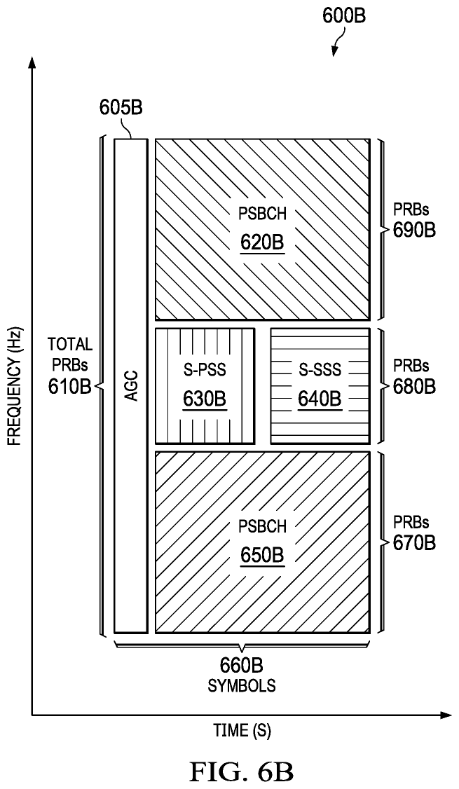

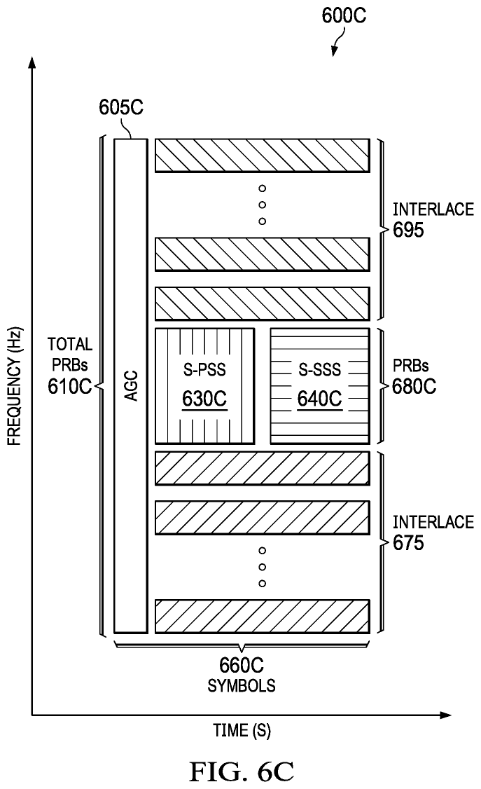

FIGS. 5A-6C are diagrams illustrating examples of S-SSB structures, in accordance with one or more embodiments. In FIGS. 5A-5C, resources are selected for various PSBCH locations (i.e., multiple PRBs), S-PSS locations, and S-SSS locations. In FIGS. 6A-6C, resources are selected for various AGC locations in addition to the PSBCH locations, the S-PSS locations, and the S-SSS locations. In some embodiments, configuration parameters may define an SCS that is used for S-SSB and for PSCCH/PSSCH resource selection. FIGS. 5A-6C include S-SSB structures in which PRBs are selected vertically in a frequency range (in hertz (Hz) and horizontally in a time domain (measured in seconds(s)).

As shown in FIGS. 5A-5C, a terminal configuring the S-SSB structure may know the SCS when acquiring resource pool (pre-)configurations. In the frequency domain, an S-SSB may be defined for two values of SCS. At SCS=30 kilohertz (KHz), a single listen-before-talk (“LBT”) channel of 20 megahertz (MHz) may include 50 or 51 PRBs. At this SCS, the S-PSS and the S-SSS may each occupy 11 PRBs. In some embodiments, at this SCS, the PSBCH occupies 19 PRBs on one side of a S-PSS/S-SSS pair and occupies 20 PRBs on the other side of the S-PSS/S-SSS. In other embodiments, the PSBCH occupies 19 PRBs on both sides of the S-PSS/S-SSS pair. In yet other amendments, the PSBCH occupies 20 PRBs on both sides of the S-PSS/S-SSS pair.

At SCS=15 KHz, the single LBT channel of 20 MHz may include between 100 and 106 PRBs, inclusive. The S-PSS and S-SS may each occupy 11 PRBs. In some embodiments, the PSBCH occupies 44 PRBs on one side of the S-PSS/S-SSS pair and occupies 45 PRBs on the other side of the S-PSS/S-SSS pair. In other embodiments, the PSBCH occupies 44 PRBs on both sides of the S-PSS/S-SSS pair. In yet other embodiments, the PSBCH occupies 45 PRBs on both sides of S-PSS/S-SSS pair. In additional embodiments, the PSBCH includes an interlaced RB structure with a same number of PRBs as that for SCS=30 KHz.

FIG. 5A illustrates an example S-SSB structure with SCS=30 KHz. In this case, symbols 560A is equal to 4 symbols and total PRBs 510A is equal to 50 PRBs. As described above, PRBs 580A selected for S-PSS 530A and S-SSS 540A are equal to 11 PRBs on the frequency range over 2 symbols each in the time domain. Further, PRBs 590A selected for a first portion of a PSBCH is equal to 20 PRBs. In turn, PRBs 570A selected for a second portion of the PSBCH 550A is equal to 19 PRBs.

FIG. 5B illustrates an example S-SSB structure with SCS=15 KHz. In this case, symbols 560B is equal to 4 symbols and total PRBs 510B is equal to 100 PRBs. As described above, PRBs 580B selected for S-PSS 530B and S-SSS 540B are equal to 11 PRBs on the frequency range over 2 symbols each in the time domain. Further, PRBs 590B selected for a first portion of the PSBCH is equal to 45 PRBs. In turn, PRBs 570B selected for a second portion of the PSBCH 550B is equal to 44 PRBs.

FIG. 5C illustrates an example S-SSB structure with SCS=15 KHz and an interlace structure. In this case, symbols 560C is equal to 4 symbols and total number of PRBs for the PSBCH is equal to a same number of the PSBCH PRBs when the SCS=30 KHz (e.g., 39-40 PRBs based on the S-SSB frequency structure). As described above, PRBs 580C selected for S-PSS 530C and S-SSS 540C are equal to 11 PRBs on the frequency range over 2 symbols each in the time domain. Further, interlace 595 selected for the first portion of the PSBCH may be same number of PRBs when the SCS=30 KHz (e.g., 19 or 20 PRBs based on the S-SSB frequency structure). Similarly, interlaces 575 selected for the second portion of the PSBCH may be equal to 19 or 20 PRBs.

Turning to FIGS. 6A-6C, the S-SSB structure may be equal to those described with respect to FIGS. 5A-5C with the addition of an AGC symbol. Thus, the AGC symbol may be added in the S-SSB structure. The AGC symbol may be the copy of the first S-PSS symbol in the S-SSB structure of the last S-SSS symbol in the S-SSB structure.

FIG. 6A illustrates an example S-SSB structure with SCS=30 KHz. In this case, symbols 660A is equal to 5 symbols (e.g., 4 symbols as described above plus the AGC symbol) and total PRBs 610A is equal to 50 PRBs. As described above, PRBs 680A selected for S-PSS 630A and S-SSS 640A are equal to 11 PRBs on the frequency range over 2 symbols each in the time domain. Further, PRBs 690A selected for the first portion of the PSBCH is equal to 20 PRBs. In turn, PRBs 670A selected for the second portion of the PSBCH 650A is equal to 19 PRBs.

FIG. 6B illustrates an example S-SSB structure with SCS=15 KHz. In this case, symbols 660B is equal to 5 symbols (e.g., 4 symbols as described above plus the AGC symbol) and total PRBs 610B is equal to 100 PRBs. As described above, PRBs 680B selected for S-PSS 630B and S-SSS 640B are equal to 11 PRBs on the frequency range over 2 symbols each in the time domain. Further, PRBs 690B selected for the first portion of the PSBCH is equal to 45 PRBs. In turn, PRBs 670B selected for the second portion of the PSBCH 650B is equal to 44 PRBs.

FIG. 6C illustrates an example S-SSB structure with SCS=15 KHz and an interlace structure. In this case, symbols 660C is equal to 5 symbols (e.g., 4 symbols as described above plus the AGC symbol) and total PRBs 610C is equal to a same PRBs selection when the SCS=30 KHz (e.g., 49-51 PRBs based on the S-SSB frequency structure). As described above, PRBs 680C selected for S-PSS 630C and S-SSS 640C are equal to 11 PRBs on the frequency range over 2 symbols each in the time domain. Further, interlace 695 selected for the first portion of the PSBCH may be same number of PRBs when the SCS=30 KHz (e.g., 19 or 20 PRBs based on the S-SSB frequency structure). Similarly, interlaces 675 selected for the second portion of the PSBCH 650B may be equal to 19 or 20 PRBs.

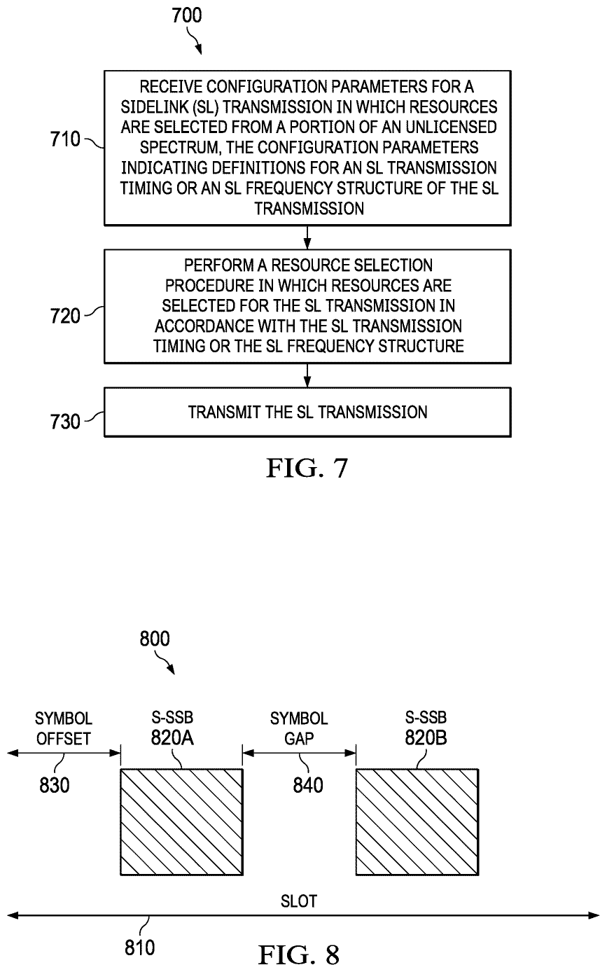

Turning to FIG. 7, the method 700 may be performed by a terminal transmitting or receiving Sl transmissions, in accordance with one or more embodiments. At 710, the flowchart begins with a terminal configured to receive configuration parameters for an SL transmission that includes resources selected from a portion of an unlicensed spectrum. The terminal may receive parameters defining an S-SSB structure and an SCS in the manner described in reference to FIGS. 5A-6C.

At 720, the flowchart continues with the terminal configured to perform a resource selection procedure, in which resources are selected for the SL transmission in accordance with the SL transmission timing of the SL frequency structure. As defined above, the SL transmission timing may be an S-SSB transmission timing that defines time domain locations in the S-SSB structure. Similarly, the SL frequency structure may be an S-SSB frequency structure that defines frequency range locations in the S-SSB structure.

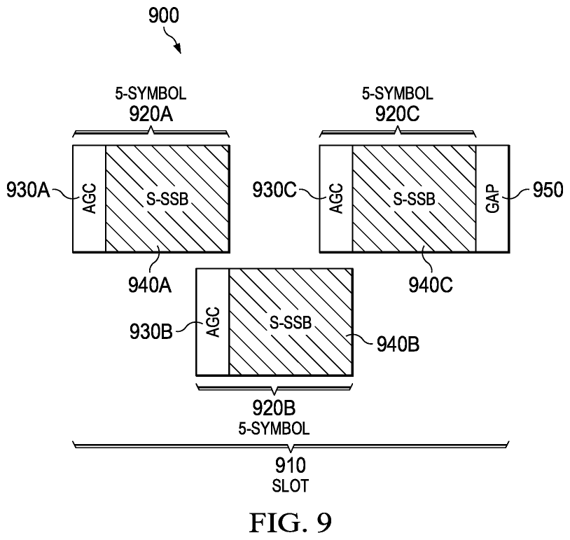

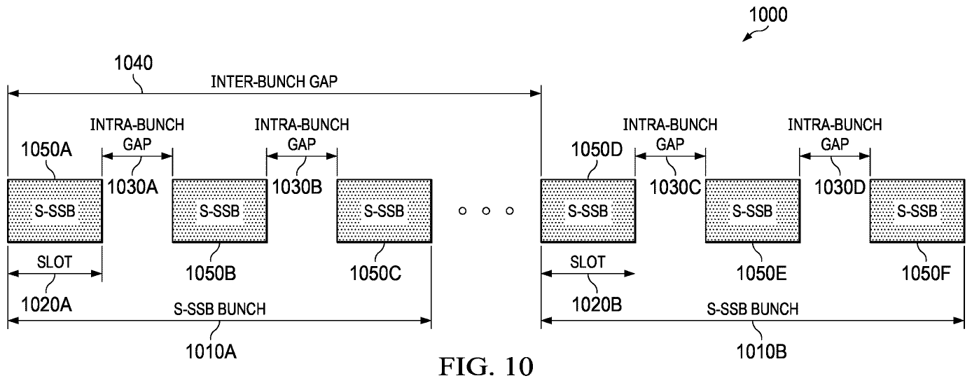

The flowchart ends at 730 where the terminal transmits the SL transmission. The SL transmission may include the resources configured in accordance with the S-SSB structure. As it will be shown in reference to FIGS. 9-10, the SL transmissions may be configured to include multiple S-SSBs in a same slot. A slot having 14 symbols may include multiple S-SSBs configured for 4 symbols or 5 symbols including the AGC symbol.

FIG. 8 illustrates an example of an SL transmission 800, in accordance with one or more embodiments. In this example, candidate S-SSB occasions for the SL transmission 800 are selected in a slot 810. The slot 810 includes a symbol offset 830, a first S-SSB 820A, a symbol gap 840, and a second S-SSB 820B. In the SL transmission 800, the symbol offset 830 is located before the first S-SSB 820A at a start (e.g., beginning) of the slot 810. The symbol gap 840 may be located between the first S-SSB 820 and the second S-SSB 820B. In some embodiments, due to LBT failure, multiple S-SSB occasions may be used to ensure that the S-SSB is transmitted in the slot 810. The candidate S-SSB occasions may be (pre-)configuration based on configuration parameters associated with an SL resource pool or SL-BWP.

In some embodiments, the S-SSB structure may be (pre-)configured for a 4-symbol or 5-symbol S-SSB structure. A number of S-SSB occasions in the slot 810 may be (pre-)configured or pre-defined. A configurable number of S-SSB occasions may be equal to 1, 2, or 3. At any given point, only a single S-SSB may need to be transmitted within the 810 slot. The number of S-SSB occasions in the slot 810 may depend on a SCS. In this case, a larger number of S-SSB occasions may be selected for a higher SCS. The symbol locations of S-SSB occasions in the slot 810 may be (pre-)configured. As shown in FIG. 8, a starting symbol location in the slot 810 may be configured for the first S-SSB 820A and the gap between two candidate S-SSB occasions. The gap may be selected from the ending or starting symbol of a first S-SSB structure to a starting symbol of a second S-SSB structure.

Turning to FIG. 9, an example of an SL transmission 900 is shown, in accordance with one or more embodiments. In this example, candidate S-SSB occasions for the SL transmission 900 are selected in a slot 910. The slot 910 includes 5-symbol S-SSB structure configurations for three S-SSBs. The slot 910 includes a first S-SSB 920A, a second S-SSB 920B, and a third S-SSB 920C. Each S-SSB includes a corresponding AGC symbol 930-930C. To allocate the three 5-symbol transmissions, the AGC symbol 930B and the AGC symbol 930C may overlap the last symbol in the S-SSB 940A and the last symbol in the S-SSB 940B, respectively. This configuration adds up to 13 symbols, which allows the last symbol in the slot 910 to be used as a gap 950. As shown in FIG. 9, multiple 5-symbol S-SSB occasions may be transmitted. In this S-SSB structure, the AGC symbol of the second SSB is the same as the last symbol of the first S-SSB. Similarly, the AGC symbol of the third S-SSB is the same as the last symbol of the second S-SSB. As a result, the last symbol of the slot may be used as the gap 950.

FIG. 10 illustrates an example of an SL communication procedure 1000, in accordance with one or more embodiments. In the SL communication procedure 1000, multiple candidate S-SSB occasions are configured for individual transmission in a dedicated slot. In FIG. 10, six S-SSB occasions 1050A-1050F are shown within two separate S-SSB bunches 1010A and 1010B. The S-SSB bunch 1010A includes S-SSB occasions 1050A-1050C. The S-SSB occasion 1050A is separated from the S-SSB occasion 1050B by an intra-bunch gap 1030A. Further, the S-SSB occasion 1050B is separated from the S-SSB occasion 1050C by an intra-bunch gap 1030B. Similarly, the S-SSB bunch 1010B includes S-SSB occasions 1050D-1050F. The S-SSB occasion 1050D is separated from the S-SSB occasion 1050E by an intra-bunch gap 1030C. Further, the S-SSB occasion 1050E is separated from the S-SSB occasion 1050F by an intra-bunch gap 1030D. As indicated by slots 1020A and 1020B, each S-SSB in the SL communication procedure is transmitted over an entire slot. In some embodiments, the S-SSB structures described in relation to FIGS. 8 and 9 may be implemented in slots 1020A and/or 1020B. The S-SSB bunch 1010A is separated from the S-SSB bunch 1010B by the inter-bunch gap 1040, which extends from a first symbol of the S-SSB bunch 1010A to a location just before the first symbol of the S-SSB bunch 1010B.

In some embodiments, candidate S-SSB occasions may be (pre-)configured in accordance with a 4-symbol S-SSB structure, a 5-symbol S-SSB structure, or a whole slot S-SSB structure. Further, a number of S-SSB slots in a bunch may be (pre-)configured or pre-defined. Only a single S-SSB may be needed to be transmitted within an S-SSB burst window. In the example of FIG. 10, the number of S-SSB slots in a bunch may depend on a value of SCS. In some embodiments, a larger number of S-SSB slots may be used for a higher SCS value. A time gap between S-SSB slots in a bunch may be (pre-)configured. Intra-bunch gaps may/may not include the first S-SSB slot. The number of S-SSB bunches in a given S-SSB periodicity may be (pre-)configured or pre-defined. The S-SSB periodicity may be one of the periodicity values described in reference to TS 38.331 of the 3GPP standard.

In some embodiments, the number of S-SSB bunches may depend on a value of the SCS. In these cases, larger numbers of S-SSB bunches may be used for higher SCS values. A time gap between the S-SSB bunches may be (pre-)configured. Inter-bunch gaps may be between the first S-SSB slot of a first S-SSB bunch and the first S-SSB slot of a second S-SSB bunch. A gap may/may not include the first S-SSB slot of a first S-SSB bunch.

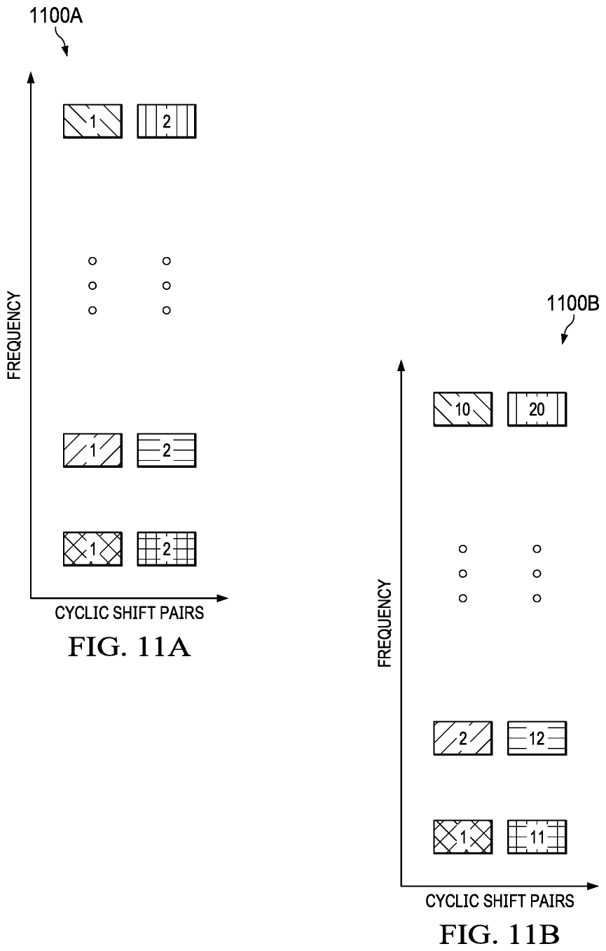

FIGS. 11A and 11B illustrate examples of configuring a PSFCH transmission to meet a predetermined reporting requirement, in accordance with one or more embodiments. FIG. 11A shows selecting resources 1100A for individual interlaces such that adjacent cycling shift pairs solely provide increasing of an indexing that is maintained on a same symbol. FIG. 11B shows selecting resources 1100B for subsequent interlaces such that adjacent cycling shift pairs continue to provide increasing of an indexing. The indexing increases from a first interlace to a second interlace. Each interlace is maintained on a same symbol. In some embodiments, in a case of interlaced PSFCH transmissions, PSFCH capacity may be limited in a groupcast ACK/NACK feedback. In unicast or groupcast NACK only feedback, all terminals configured for reception (“Rx terminals”) may use a single PSFCH resource. The PSFCH capacity may be large enough as a result. In groupcast ACK/NACK feedback, each Rx terminal may send an ACK or NACK in a dedicated PSFCH resource. Multiple PSFCH resources may be required in this case. In some embodiments, a PSFCH transmission uses the same interlace as the corresponding PSCCH/PSSCH transmission.

In a case where a PSFCH periodicity is larger than 1 slot, different cyclic shift pairs may be selected for PSCCH/PSSCH transmissions over different slots in a same interlace. In this case, multiple cyclic shift pairs are treated as independent PSFCH resources. Each PSSCH transmission in an interlace may include a corresponding PSFCH interlace. All the cyclic shifts in an interlace may belong to different PSFCH resources for the PSSCH transmission. In unicast or groupcast with NACK only feedback, a single cyclic shift may be used over a whole interlace. In groupcast with ACK/NACK feedback, group members may share an interlaced PSFCH transmission. Each group member may determine specific cyclic shifts that used the PSFCH transmission, based on a member ID (“M_{ID}”) and a physical layer source ID (“P_{ID}”). A total number of PSFCH resources may be obtained based on a number N of cyclic shift pairs. If a PSSCH transmission occupies K interlaces, then the total number of PSFCH resources may be given by K*N, based on an SL resource pool (pre-)configuration. The Rx terminal may determine a corresponding PSFCH resource (or cyclic shift) as (P_{ID}+M_{ID}) mod (N*K).

In one or more embodiments, the PSFCH resource occupies part of interlace in groupcast ACK/NACK feedback. In this case, multiple PRBs and cyclic shift pairs may be treated as independent PSFCH resources in groupcast ACK/NACK feedback. Group members may share the interlaced PSFCH transmission. Each group member may determine which PRBs and cyclic shift pair are used in an interlace for that member's PSFCH transmission, based on its member ID (M_{ID}) and physical layer source ID (P_{ID}). In some embodiments, an interlace includes a number M of PRBs, and there may be a number N of cyclic shift pairs. In some embodiments, a total number of PSFCH resources may be given by M*N. The PSFCH resources may be indexed in frequency first, code second rule. If a PSSCH transmission occupies K interlaces, then a total number of PSFCH resources may be given by K*M*N, based on an SL resource pool (pre)configuration.

In one or more embodiments, each Rx terminal may transmit a PSFCH transmission on both a common PSFCH resource and a dedicated PSFCH resource. In this case, a number M of contiguous PSFCH resources may be used for common transmission by all Rx terminals to achieve the OCB requirement. These M contiguous PSFCH resources may occupy the whole interlace to achieve the OCB requirement. Each terminal may transmit on these M contiguous, common, PSFCH resources, in addition to transmit on another dedicated PSFCH resource. PSFCH resources dedicated to the Rx terminal may be determined by (P_{ID}+M_{ID}) mod ((M*K−1)*N). The Rx terminal may transmit the PSFCH transmission on only dedicated PSFCH resources. In some embodiments, the Rx terminal may determine its dedicated PSFCH resource as (P_{ID}+M_{ID}) mod (M*N*K). If the total number of Rx terminals is less than M, then the remaining PRBs of an interlace may be transmitted by a particular Rx terminal. The particular Rx terminal may be one configured with the smallest member ID, configured with the largest member ID, or configured by higher layer signaling.

In one or more embodiments, a configurable number of PSFCH interlaces may be defined based on a number A of sub-channels for PSFCH transmissions, a number of slots B for PSFCH periodicity, a number C of interlaces selected for the PSFCH transmissions, and a number D of cyclic shift pairs selected for a corresponding PSFCH transmission. Each PSSCH resource may include a number E of PSFCH resources where

$$E = ⌊ \frac{C \cdot D}{A \cdot B} ⌋ ,$$

where A is equal to a number of sub-channels available for PSSCH transmissions, B is equal to a number of periodicity slots in the PSFCH, C is equal to a number of PSFCH interlaces, and D is equal to a number of cyclic shift pairs. In some embodiments, the PSFCH periodicity may be B slots (e.g., B=1, 2, 4). Further, the total number of PSSCH resources corresponding to the PSFCH resources in a slot is A*B. In some embodiments, only C interlaces are selected for PSFCH transmissions. As a result, C may be less than or equal to A. Further, C may be (pre-)configured per an SL resource pool. For C less than A, then a part of the interlaces may be used for the PSFCH transmissions. In this regard, D cyclic shift pairs may be (pre-)configured per resource pool for PSFCH transmissions.

The PSFCH resources may be indexed based on a cyclic shift pair selection or an interlace selection. The total number of PSFCH resources in a slot may be defined by C*D. The PSFCH resources may be indexed based on a cyclic shift pair (code domain) or an interlace (frequency domain). In some embodiments, the PSFCH resources are indexed based on cyclic shift pair (code domain) first, interlace (frequency domain) second rule. In some embodiments, the PSFCH resources are indexed based on interlace (frequency domain) first, cyclic shift pair (code domain) second rule. For a PSSCH transmission in a slot u, 0≤u≤B, and sub-channel v, 0≤v≤A, the corresponding PSFCH resources are indexed in [(u+v*B)*E, (u+1+v*B)*E−1] or indexed in [(v+u*A)*E, (v+1+u*A)*E−1]].

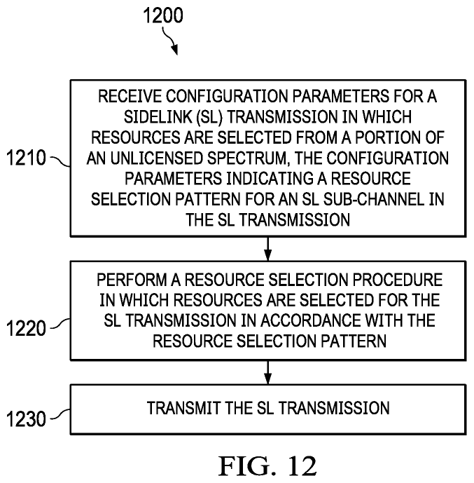

Turning to FIG. 12, a flowchart is shown, detailing a method 1200 of transmitting an SL transmission, in accordance with one or more embodiments. In this example, the method 1200 is executed by a terminal exchanging information via SL communication links established with a base station and/or one or more neighboring terminals. [the SL transmission includes a Physical Sidelink Feedback Channel (“PSFCH”) transmission that meets an Occupied Channel Bandwidth (“OCB”)/Power Spectral Density (“PSD”) requirement, the PSFCH transmission uses a same interlace as a corresponding Physical Sideling Control Channel (“PSCCH”)/Physical Sidelink Shared Channel (“PSSCH”) transmission]

At 1210, the flowchart begins with a terminal configured to receive configuration parameters for an SL transmission that includes resources selected from a portion of an unlicensed spectrum. The configuration parameters may indicate a resource selection pattern for an SL sub-channel in the SL transmission. As described above, the unlicensed spectrum are individual unlicensed bands in a bandwidth with a range between 4.1 gigahertz (GHz) and 7.125 GHz. [when a periodicity of the PSFCH transmission is larger than one slot, different cyclic shift pairs are selected for the corresponding PSCCH/PSSCH transmission over different slots and in a same interlace]

At 1220, the flowchart continues where the terminal performs a resource selection procedure in which resources are selected for the SL transmission in accordance with the resource selection pattern.

The flowchart ends at 1230, where the terminal transmits an SL transmission including resources selected in accordance with the resource selection procedure. The resource selection procedure may include selecting resources to perform one or more PSFCH transmissions using PSFCH resources that occupy a part of an interlace in a groupcast ACK/NACK feedback transmission.

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A terminal comprising:
a receiver configured to receive configuration parameters for a sidelink (SL) transmission that includes resources selected from a portion of an unlicensed spectrum, the configuration parameters indicating definitions for an a Sidelink synchronization signal block (“S-SSB”) transmission timing or an S-SSB frequency structure of the SL transmission;
a processor configured to perform a resource selection procedure that includes resources selected for the SL transmission in accordance with the S-SSB transmission timing or the S-SSB frequency structure; and
a transmitter configured to transmit, the SL transmission.

2. The terminal of claim 1, wherein:
the S-SSB frequency structure includes a numerology and a resource selection information.

3. The terminal of claim 2, wherein:
the numerology indicates that a subcarrier spacing is equal to a first value or a second value, the first value being larger than the second value.

4. The terminal of claim 3, wherein:
the resource selection information selects a first number of resources to a first portion of a Physical Sidelink Broadcasting Channel (“PSBCH”) and selects a second number of resources to a second portion of the PSBCH.

5. The terminal of claim 4, wherein:
when the subcarrier spacing is equal to the first value, the resource selection information selects a first set of resources to the first portion of the PSBCH,
when the subcarrier spacing is equal to the second value, the resource selection information selects a second set of resources to the first portion of the PSBCH, the second set of resources being equal to or larger than the first set of resources.

6. The terminal of claim 5, wherein:
the resource selection information indicates an interlace structure for the second set of resources, the interlace structure indicates whether the second set of resources is equal to or larger than the first set of resources.

7. The terminal of claim 4, wherein:
the first number of resources is greater than the second number of resources.

8. (canceled)

9. (canceled)

10. The terminal of claim 4, wherein:
the resource selection information selects resources for an automatic gain control (“AGC”) symbol, the AGC symbol being a copy of a first SL Primary Synchronization Signal (“S-PSS”) symbol or a last SL Secondary Synchronization Signal (“S-SSS”) symbol in the S-SSB frequency structure.

11. The terminal of claim 1, wherein:
the S-SSB transmission timing indicates a Sidelink synchronization signal block (“S-SSB”) timing structure for the SL transmission.

12. The terminal of claim 11, wherein:
the S-SSB timing structure includes a resource selection information defining at least one S-SSB occasion in a slot, a number of S-SSB occasions in the slot being configured, preconfigured, or predefined.

13. The terminal of claim 12, wherein:
the S-SSB occasion includes a duration of four symbols or five symbols in the slot, the duration being configured, preconfigured, or predefined.

14. The terminal of claim 12, wherein:
the resource selection information indicates locations in the slot for a symbol offset, a first S-SSB occasion, a symbol gap, and a second S-SSB occasion,
the symbol offset being at a beginning of the slot and before the first S-SSB occasion, and
the symbol gap being between the first S-SSB occasion and the second S-SSB occasion.

15. The terminal of claim 12, wherein:
the S-SSB occasion includes a duration of four symbols and one automatic gain control (“AGC”) symbol in the slot.

16. The terminal of claim 15, wherein:
the resource selection information indicates locations in the slot a first AGC symbol, a second AGC symbol, a third AGC symbol, a first S-SSB occasion, a second S-SSB occasion, a third S-SSB occasion, and a symbol gap
the first AGC is at a beginning of the slot and before the first S-SSB occasion,
the second AGC overlaps a last symbol of the first S-SSB occasion and before the second S-SSB occasion,
the third AGC overlaps a last symbol of the second S-SSB occasion and before the third S-SSB occasion, and
the symbol gap being the last symbol in the slot.

17. (canceled)

18. The terminal of claim 11, wherein:
the S-SSB timing structure includes a resource selection information defining a plurality of S-SSB slot occasions in a plurality of S-SSB bunches, a number of the plurality of S-SSB slot occasions in the S-SSB bunches, and a number of the plurality of S-SSB bunches are configured, preconfigured, or predefined.

19. The terminal of claim 18, wherein:
the plurality of S-SSB slot occasions in the plurality of S-SSB bunches, the number of the plurality of S-SSB slot occasions in the S-SSB bunches, and the number of the plurality of S-SSB bunches are configured, preconfigured, or predefined.

20. The terminal of claim 19, wherein:
the number of the plurality of S-SSB bunches is defined in reference to a predetermined S-SSB periodicity, and
the number of the plurality of S-SSB bunches is based on a subcarrier spacing.

21. The terminal of claim 18, wherein:
the resource selection information indicates locations in the plurality of S-SSB bunches for the plurality of S-SSB slot occasions, a plurality of intra-bunch gaps, and at least one inter-bunch gap,
two subsequent S-SSB slot occasions out of the plurality of S-SSB slot occasions are separated by one intra-bunch gap out of plurality of intra-bunch gaps, and
the inter-bunch gap is located between a start of a first S-SSB slot occasion in a first S-SSB bunch and a start of a first S-SSB slot occasion in a second S-SSB bunch.

22. A method comprising:
receiving configuration parameters for a sidelink (SL) transmission that includes resources selected from a portion of an unlicensed spectrum, the configuration parameters indicating definitions for an a Sidelink synchronization signal block (“S-SSB”) transmission timing or an S-SSB frequency structure of the SL transmission;
performing a resource selection procedure that includes resources selected for the SL transmission in accordance with the S-SSB transmission timing or the S-SSB frequency structure; and
transmitting the SL.

23.-33. (canceled)

34. A non-transitory computer-readable medium that stores instructions that, when executed, cause a terminal to:
receive configuration parameters for a sidelink (SL) transmission that includes resources selected from a portion of an unlicensed spectrum, the configuration parameters indicating definitions for an a Sidelink synchronization signal block (“S-SSB”) transmission timing or an S-SSB frequency structure of the SL transmission;
perform a resource selection procedure that includes resources selected for the SL transmission in accordance with the S-SSB transmission timing or the S-SSB frequency structure; and
transmit the SL transmission.
